(19) United States
(12) Patent Application Publication
(10) Pub. No.: US 2026/0128703 A1
(43) Pub. Date: May 7, 2026

(54) RAILROAD-CAR POWER CONVERSION APPARATUS

(71) Applicant: Mitsubishi Electric Corporation, Chiyoda-ku, Tokyo (JP)

(72) Inventors: Ryosuke NAKAGAWA, Tokyo (JP); Yasuhiro SHIRAKI, Tokyo (JP)

(73) Assignee: Mitsubishi Electric Corporation, Chiyoda-ku, Tokyo (JP)

(21) Appl. No.: 19/117,434

(22) PCT Filed: Nov. 16, 2022
(86) PCT No.: PCT/JP2022/042574

§ 371 Date: Apr. 1, 2025

(51) Int. Cl. H02P 27/06; H01F 30/12; H02M 1/12; H02M 7/5387

(52) U.S. Cl. CPC H02P 27/06; H01F 30/12; H02M 1/123; H02M 7/53871

(57) ABSTRACT

A power conversion apparatus includes: a three-phase inverter converting direct-current power into alternating-current power for a propulsion motor; and a magnetic core. The magnetic core includes: first and second cores penetrated by both a three-phase alternating-current power line and a common mode current circulation line; and a third core penetrated only by the three-phase alternating-current power line. The first core is disposed on a side closer to the three-phase inverter, the second core is disposed on a side closer to the propulsion motor, and the third core is disposed between the first core and the second core. In the first, second, and third cores, when at least one of three electric wires in the three-phase alternating-current power line is drawn out of the second core toward the propulsion motor, the at least one of the three electric wires is not in parallel with remaining one or two electric wires.

### FIELD

The present disclosure relates to a railroad-car power conversion apparatus for driving a propulsion motor installed on a railroad car.

### BACKGROUND

A power conversion apparatus includes a switching element such as an insulated gate bipolar transistor (IGBT) or a metal-oxide-semiconductor field-effect-transistor (MOSFET). In power conversion apparatuses of recent years, switching voltage and switching operation speed are increasing along with an increase in the withstand voltage and frequency of switching elements.

In general, it is known that switching operation performed in a power conversion apparatus causes common mode current which is zero-phase current. It is also known that switching operation performed in a power conversion apparatus causes leakage current flowing to the ground via a parasitic capacitance located between the ground and an alternating-current power line connecting the power conversion apparatus and a load. In addition, it is also known that switching operation performed in a power conversion apparatus causes leakage current flowing to a peripheral device other than a load via a parasitic capacitance located between an alternating-current power line and a housing accommodating the power conversion apparatus. These leakage currents are distinguished from zero-phase currents, as common mode currents flowing through a grounding system.

As described above, an increase in switching voltage and switching operation speed will increase zero-phase current and leakage current, and increase radiation noise and conduction noise. Thus, there is a problem in that the increase in switching voltage and switching operation speed adversely affect peripheral communication devices and the like.

In order to reduce zero-phase current, in the conventional techniques, alternating-current power lines are wound around or passed through the same magnetic core. In addition, Patent Literature 1 below discloses a technique in which in order to reduce leakage current, a ground terminal of a power conversion apparatus and a ground terminal of a load are connected by an electric wire called a common mode current circulation line, and alternating-current power lines and the common mode current circulation line are wound around or passed through the same magnetic core.

### Citation List

### Patent Literature

Patent Literature 1: Japanese Patent Application Laid-open No. 2001-086734

### SUMMARY OF INVENTION

### Problem to Be Solved by the Invention

When the technique of Patent Literature 1 is used, the impedance of a circulation loop of a ground circuit is larger than the impedance of a circulation loop of the common mode current circulation line. Therefore, leakage current flowing through the circulation loop of the ground circuit can be reduced. However, it is described that when the technique of Patent Literature 1 is used, a peak value of zero-phase current is larger than when only the alternating-current power lines are wound around or passed through the same magnetic core. As described above, zero-phase current causes radiation noise and conduction noise. In the case of a railroad-car power conversion apparatus, since an extremely large current flows through a propulsion motor serving as a load, an increase in zero-phase current cannot be tolerated.

The present disclosure has been made in view of the above, and an object of the present disclosure is to obtain a railroad-car power conversion apparatus capable of reducing leakage current while preventing an increase in zero-phase current.

### Means to Solve the Problem

In order to solve the above-described problem and achieve the object, a railroad-car power conversion apparatus according to the present disclosure is a railroad-car power conversion apparatus for driving a propulsion motor installed on a railroad car, the railroad-car power conversion apparatus including: a three-phase inverter that converts direct-current power into alternating-current power for the propulsion motor; and a magnetic core penetrated by a three-phase alternating-current power line and a common mode current circulation line. The three-phase alternating-current power line is an electric wire that connects the three-phase inverter and the propulsion motor. The common mode current circulation line is an electric wire that connects a ground potential of the power conversion apparatus and a ground potential of the propulsion motor. The magnetic core includes: first and second cores penetrated by both the three-phase alternating-current power line and the common mode current circulation line; and a third core penetrated only by the three-phase alternating-current power line. The first core is disposed on a side closer to the three-phase inverter, and the second core is disposed on a side closer to the propulsion motor. In addition, the third core is disposed between the first core and the second core. Assuming that, in each of the first core, the second core, and the third core, a first surface is defined as a surface facing toward the three-phase inverter, and a second surface is defined as a surface facing toward the propulsion motor, when at least one of three electric wires included in the three-phase alternating-current power line is drawn out of the second core toward the second surface, the at least one of the three electric wires is not in parallel with remaining one or two electric wires.

### Effects of the Invention

The railroad-car power conversion apparatus according to the present disclosure has an effect of allowing leakage current to be reduced while preventing an increase in zero-phase current.

### BRIEF DESCRIPTION OF DRAWINGS

FIG. 1 is a diagram illustrating an exemplary configuration of an electrical system of a railroad car system including a power conversion apparatus according to a first embodiment.

FIG. 2 is a diagram illustrating an exemplary variation of an input circuit unit illustrated in FIG. 1.

FIG. 3 is a diagram for describing a configuration of a magnetic core included in the power conversion apparatus according to the first embodiment and a positional relationship between a three-phase alternating-current power line and a common mode current circulation line.

FIG. 4 is a diagram for describing an effect to be achieved in the case of using the magnetic core included in the power conversion apparatus according to the first embodiment.

FIG. 5 is a diagram illustrating an exemplary configuration of the magnetic core according to the first embodiment, used in electromagnetic field analysis.

FIG. 6 is a diagram illustrating an exemplary configuration of a magnetic core given as a comparative example for comparison with the configuration illustrated in FIG. 5.

FIG. 7 is a diagram for describing electromagnetic field analysis performed on the magnetic cores configured as illustrated in FIGS. 5 and 6.

FIG. 8 is a diagram for describing the reason why analysis results illustrated in FIG. 7 were obtained.

FIG. 9 is a diagram illustrating a situation in which local magnetic flux described in the first embodiment is generated, on a configuration diagram of the magnetic core of FIG. 4.

FIG. 10 is a diagram for describing a configuration of a magnetic core included in a power conversion apparatus according to a second embodiment.

FIG. 11 is a diagram for describing a configuration of a magnetic core included in a power conversion apparatus according to a fourth embodiment.

FIG. 12 is a diagram for describing a configuration of a magnetic core included in a power conversion apparatus according to a fifth embodiment.

### DESCRIPTION OF EMBODIMENTS

Railroad-car power conversion apparatuses (hereinafter, abbreviated as “power conversion apparatuses” as appropriate) according to embodiments of the present disclosure will be described below in detail with reference to the accompanying drawings. Note that for ease of understanding, the reduction scale of each member may be different from the actual scale in the accompanying drawings. The reduction scale of each member may also differ between the drawings. Furthermore, in the following description, physical connection and electrical connection are simply referred to as “connection” without being distinguished from each other. That is, the term “connection” refers to both direct connection between constituent elements and indirect connection between constituent elements via another constituent element.

### First Embodiment

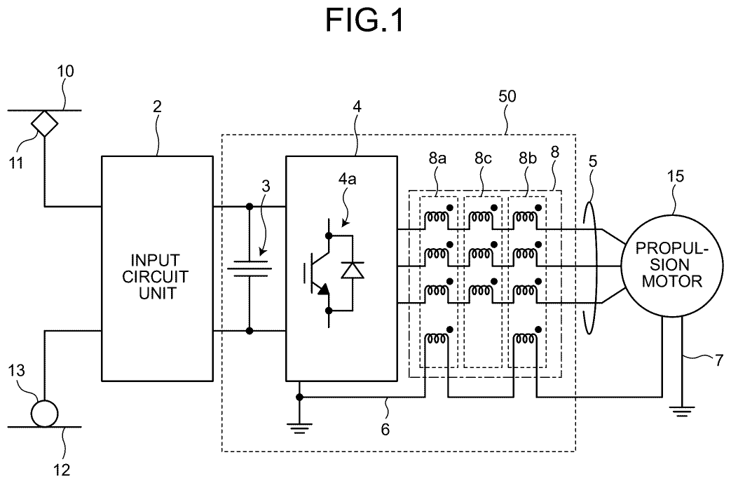

FIG. 1 is a diagram illustrating an exemplary configuration of an electrical system of a railroad car system including a power conversion apparatus 50 according to a first embodiment. The power conversion apparatus 50 according to the first embodiment includes a filter capacitor 3, a three-phase inverter 4, and a magnetic core 8. In FIG. 1, an input circuit unit 2 is connected to an input end of the three-phase inverter 4, and at least one propulsion motor 15 is connected to an output end of the three-phase inverter 4. The propulsion motor 15 is a three-phase motor that applies propulsive force to a railroad car.

The input circuit unit 2 includes at least a switch and a filter reactor. One end of the input circuit unit 2 is connected to an overhead line 10 via a current collector 11, and another end thereof is connected to a rail 12, which is a ground potential, via a wheel 13. Direct-current power or alternating-current power supplied from the overhead line 10 is input to the one end of the input circuit unit 2 via the current collector 11. A direct-current voltage generated by the direct-current power at an output end of the input circuit unit 2 is applied to the three-phase inverter 4. The filter capacitor 3 smooths the direct-current voltage to be applied to the three-phase inverter 4 so as to reduce ripples of the direct-current voltage. The three-phase inverter 4 converts direct-current power supplied via the input circuit unit 2 into alternating-current power for the propulsion motor 15.

The three-phase inverter 4 is connected to the propulsion motor 15 by a three-phase alternating-current power line 5 via the magnetic core 8. The three-phase alternating-current power line 5 is an electric wire that connects the three-phase inverter 4 and the propulsion motor 15. A housing (not illustrated) of the propulsion motor 15 is grounded by a ground wire 7. In addition, the propulsion motor 15 is connected to a portion serving as a ground potential of the power conversion apparatus 50 by a common mode current circulation line 6. The common mode current circulation line 6 is an electric wire that electrically connects the ground potential of the power conversion apparatus 50 and a ground potential of the propulsion motor 15.

The three-phase inverter 4 includes a plurality of switching elements 4a in three-phase bridge connection. Each switching element 4a includes an anti-parallel connected freewheeling diode. Each switching element 4a performs switching operation according to a gate signal output from a control unit (not illustrated). Current flowing through each switching element 4a is intermittently controlled by the switching operation of the switching element 4a. As a result, the direct-current power supplied from the input circuit unit 2 is converted into alternating-current power for the propulsion motor 15. The propulsion motor 15 is driven by the alternating-current power supplied from the three-phase inverter 4, and applies propulsive force to a train including one or more railroad cars (not illustrated). The three-phase inverter 4 drives the propulsion motor 15 by converting the direct-current power supplied via the input circuit unit 2 into alternating-current power for the propulsion motor 15. Note that although the input circuit unit 2 and the three-phase inverter 4 are illustrated as separate constituent elements in FIG. 1, the input circuit unit 2 and the three-phase inverter 4 may be accommodated in the same housing.

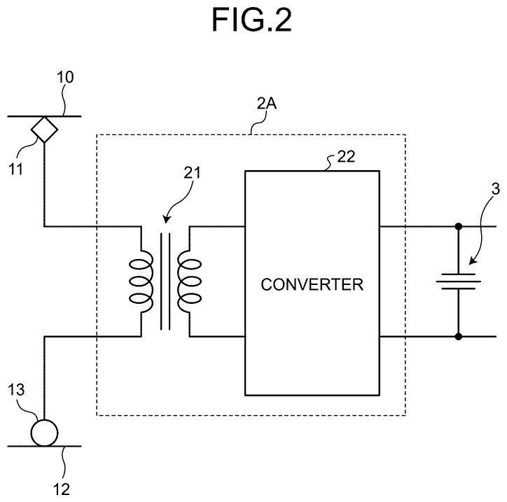

FIG. 2 is a diagram illustrating an exemplary variation of the input circuit unit 2 illustrated in FIG. 1. FIG. 2 illustrates an input circuit unit 2A as an example of a case where the overhead line 10 is an alternating-current overhead line. The input circuit unit 2A includes a main transformer 21 and a converter 22. The main transformer 21 steps down an alternating-current voltage received via the current collector 11, and applies the stepped-down alternating-current voltage to the converter 22. The converter 22 converts the stepped-down alternating-current voltage into a direct-current voltage, and applies the direct-current voltage to the three-phase inverter 4.

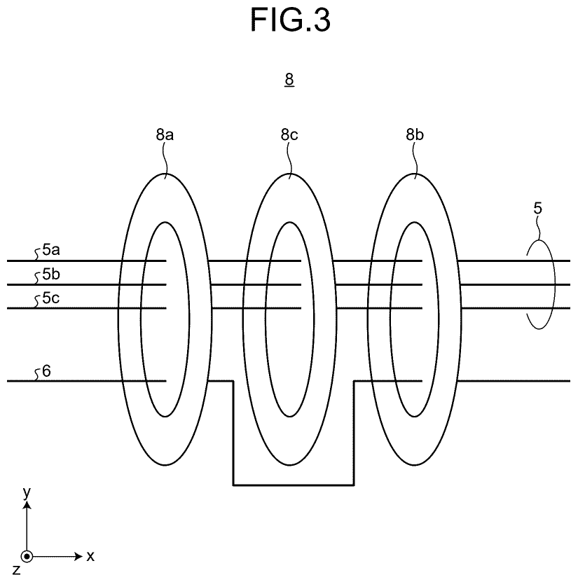

Next, a configuration and a connection form of the magnetic core 8 will be described with reference to FIGS. 1 and 3. FIG. 3 is a diagram for describing a configuration of the magnetic core 8 included in the power conversion apparatus 50 according to the first embodiment and a positional relationship between the three-phase alternating-current power line 5 and the common mode current circulation line 6.

The magnetic core 8 includes a first core 8a, a second core 8b, and a third core 8c. The first core 8a is disposed on a side closer to the three-phase inverter 4. The second core 8b is disposed on a side closer to the propulsion motor 15. The third core 8c is disposed between the first core 8a and the second core 8b. As illustrated in FIG. 3, the first core 8a, the second core 8b, and the third core 8c are formed in a circular annular shape. Note that it goes without saying that the term “circular” used herein refers not only to a perfect circular shape, but also to an elliptical shape.

Furthermore, when a first surface is defined as a surface facing toward the three-phase inverter 4, and a second surface is defined as a surface facing toward the propulsion motor 15, each of the first core 8a, the second core 8b, and the third core 8c is disposed such that the first and second surfaces are located in a yz-plane. In addition, both the three-phase alternating-current power line 5 and the common mode current circulation line 6 penetrate the first core 8a and the second core 8b. Meanwhile, only the three-phase alternating-current power line 5 out of the three-phase alternating-current power line 5 and the common mode current circulation line 6 penetrates the third core 8c. The reason for such a configuration will be described below.

The three-phase alternating-current power line 5 includes electric wires, that is, electric wires 5a, 5b, and 5c. For example, the electric wire 5a is a U-phase electric wire, the electric wire 5b is a V-phase electric wire, and the electric wire 5c is a W-phase electric wire.

Note that FIGS. 1 and 3 each illustrate the configuration in which the magnetic core 8 includes one first core 8a, one second core 8b, and one third core 8c, but the number of first cores 8a, the number of second cores 8b, and the number of third cores 8c may each be two or more. In addition, FIG. 3 illustrates a case where each core is formed in a circular annular shape, but the shape of each core is not limited thereto. Each core may be formed in a rectangular annular shape. Furthermore, when each core is formed in a rectangular annular shape, four corners of each core may be chamfered.

For example, ferrite or amorphous can be used as a material of the magnetic core 8. In addition, with regard to parameters such as the outer circumferential length, inner circumferential length, thickness, and aspect ratio of each core included in the magnetic core 8, suitable values can be used according to the capacity of the three-phase inverter 4, and the length, thickness, placement, and the like of the three-phase alternating-current power line 5. Furthermore, with regard to the magnetic permeability of the magnetic core 8, suitable values may be selected according to switching frequency, a stray capacitance between the power conversion apparatus 50 and the ground, a stray capacitance between the propulsion motor 15 and the ground, and the like.

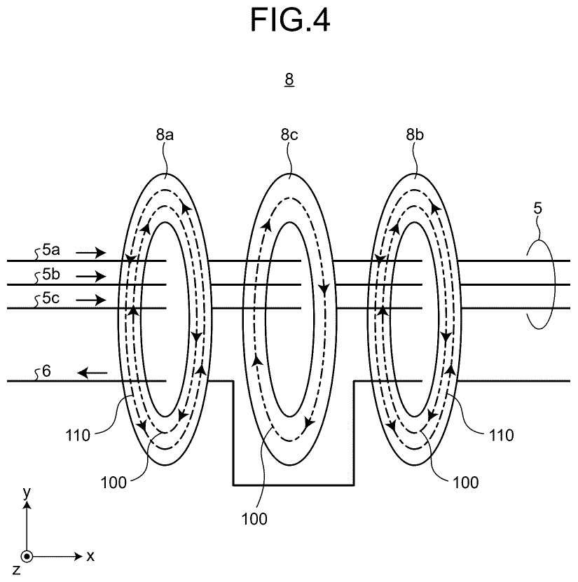

Next, an effect to be achieved in the case of using the magnetic core 8 included in the power conversion apparatus 50 according to the first embodiment will be described with reference to FIG. 4. FIG. 4 is a diagram for describing an effect to be achieved in the case of using the magnetic core 8 included in the power conversion apparatus 50 according to the first embodiment.

FIG. 4 assumes that zero-phase current flows through the three-phase alternating-current power line 5 in a direction from the left side to the right side in the drawing, and zero-phase current flows through the common mode current circulation line 6 in a direction from the right side to the left side in the drawing. At this time, magnetic fluxes 100 indicated by two-dot chain lines are generated according to the right-handed screw rule, in the first core 8a, the second core 8b, and the third core 8c penetrated by the three-phase alternating-current power line 5. In addition, magnetic fluxes 110 indicated by alternate long and short dash lines are generated in the first core 8a and the second core 8b penetrated by the common mode current circulation line 6. In the first core 8a and the second core 8b, the magnetic fluxes 100 and the magnetic fluxes 110 are opposite to each other. Thus, the magnetic fluxes 100 and the magnetic fluxes 110 cancel each other out. Therefore, magnetic flux density decreases inside the first core 8a and the second core 8b. As a result, as compared with a case where only the three-phase alternating-current power line 5 penetrates the first core 8a and the second core 8b, it is possible to greatly increase the level of zero-phase current at which magnetic saturation occurs in the first core 8a and the second core 8b.

Next, a description will be given of the reason why the common mode current circulation line 6 is not passed through the third core 8c. A description has been given above of zero-phase current as follows: zero-phase current flows through the three-phase alternating-current power line 5 in the direction from the left side to the right side in the drawing, and zero-phase current flows through the common mode current circulation line 6 in the direction from the right side to the left side in the drawing. Meanwhile, there is also an operation mode in which current flows through the common mode current circulation line 6 in the same direction as the current flowing through the three-phase alternating-current power line 5, and circulates through the ground wire 7. Although the current flowing in this operation mode is smaller than the zero-phase current, the current affects magnetic flux density inside the magnetic core 8 since the current flows in a direction in which magnetic flux is applied. In order to reduce this influence, the common mode current circulation line 6 does not penetrate the third core 8c. With this configuration, it is possible to prevent the impedance of a circulation loop of the common mode current circulation line 6 from becoming extremely smaller than the impedance of a circulation loop of a ground circuit including the ground wire 7. As a result, it is possible to obtain the effect of allowing leakage current to be reduced while preventing an increase in zero-phase current.

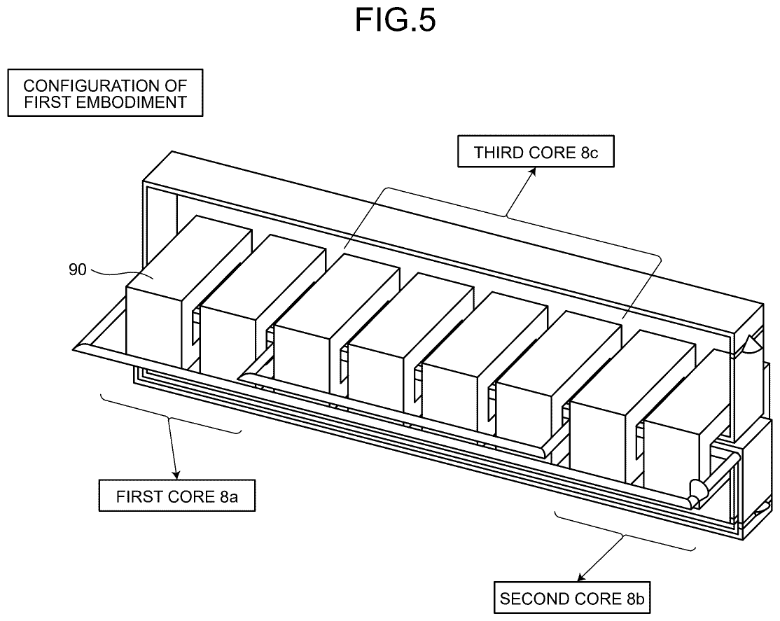

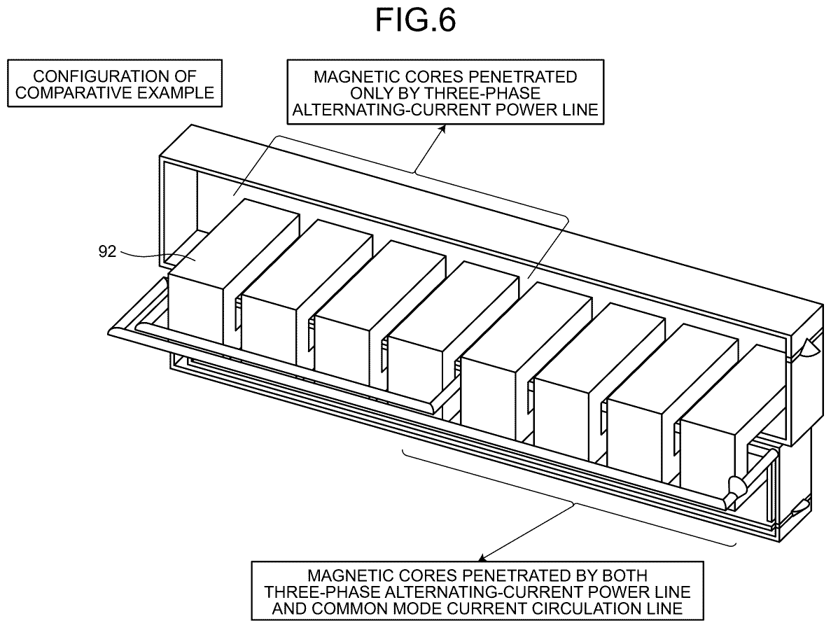

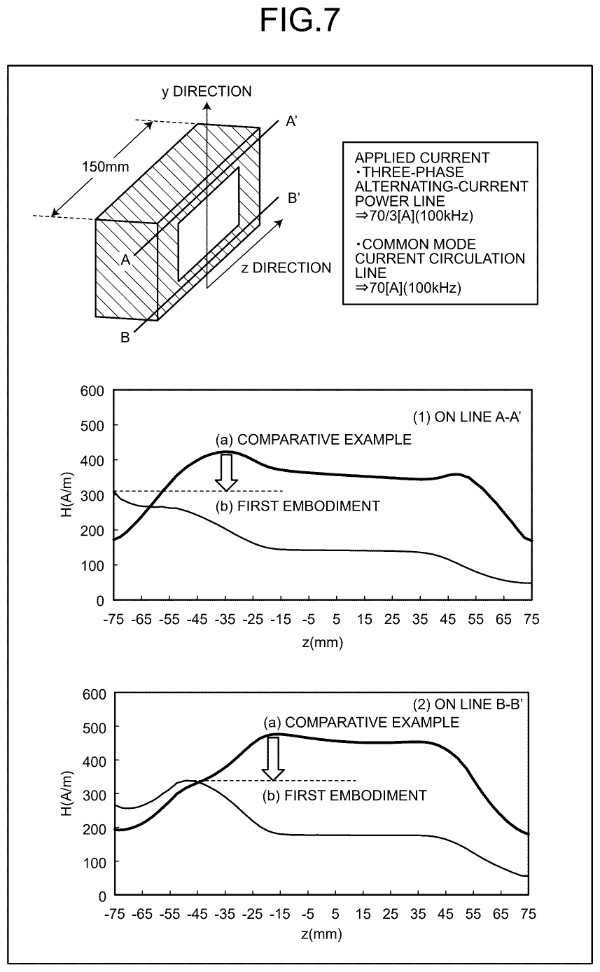

Next, another effect to be achieved by the magnetic core 8 of the first embodiment will be described with reference to FIGS. 5 to 7 illustrating an exemplary configuration, results, and the like of electromagnetic field analysis performed on the configuration including the magnetic core 8 of the first embodiment. FIG. 5 is a diagram illustrating an exemplary configuration of the magnetic core according to the first embodiment, used in electromagnetic field analysis. FIG. 6 is a diagram illustrating an exemplary configuration of a magnetic core given as a comparative example for comparison with the configuration illustrated in FIG. 5. FIG. 7 is a diagram for describing electromagnetic field analysis performed on the magnetic cores configured as illustrated in FIGS. 5 and 6.

FIG. 5 illustrates an exemplary configuration in which each of the numbers of first cores 8a and second cores 8b penetrated by both the three-phase alternating-current power line 5 and the common mode current circulation line 6 is two, and the number of third cores 8c penetrated only by the three-phase alternating-current power line 5 is four. Core members having the same structure were used for the first core 8a, the second core 8b, and the third core 8c. A member in a rectangular annular shape as illustrated in an upper part of FIG. 7 was used as each core member. The width of each core member was 150 mm in a z direction. Note that in FIG. 7, the direction of a z-axis is opposite to that in FIGS. 3 and 4.

In addition, as a comparative example, FIG. 6 illustrates an exemplary configuration in which the total number of core members is eight in the same manner, and the number of core members penetrated only by the three-phase alternating-current power line 5 and the number of core members penetrated by both the three-phase alternating-current power line 5 and the common mode current circulation line 6 are equally set to four.

Results of electromagnetic field analysis are illustrated in a middle part and a lower part of FIG. 7. The horizontal axis represents a z-directional position, and the vertical axis represents the magnitude of a magnetic field. In the case of the configuration of FIG. 5, a core member 90 was analyzed. The core member 90 is outermost one of the first cores 8a. Furthermore, in the case of the configuration of FIG. 6, a core member 92 was analyzed. The core member 92 is outermost one of the four magnetic cores penetrated only by the three-phase alternating-current power line 5. Magnetic field distribution in the magnetic core on line A-A′ is illustrated in the middle part of FIG. 7, and magnetic field distribution in the magnetic core on line B-B′ is illustrated in the lower part of FIG. 7. In each drawing, a thick solid line represents the magnetic field distribution according to the configuration of the comparative example, and a thin solid line represents the magnetic field distribution according to the configuration of the first embodiment. As also illustrated in the upper part of FIG. 7, alternating current with an amplitude of 70/3 [A] and a frequency of 100 kHz was applied to the three electric wires in the three-phase alternating-current power line 5, and alternating current with an amplitude of 70 [A] and a frequency of 100 kHz was applied to the common mode current circulation line 6. In addition, the relative permeability of each core member was 4000.

As shown in the analysis result in the middle part of FIG. 7, it can be seen that in the configuration of the first embodiment, a peak value of the magnetic field on line A-A′ decreased by about 100 (A/m) as compared with the configuration of the comparative example. Furthermore, as shown in the analysis result in the lower part of FIG. 7, it can be seen that in the configuration of the first embodiment, a peak value of the magnetic field on line B-B′ decreased by about 130 to 140 (A/m) as compared with the configuration of the comparative example. In addition, as shown in the analysis results of the middle part and the lower part of FIG. 7, it can be seen that in most regions viewed along the z-axis direction, the magnitude of the magnetic field was lower in the case of the first embodiment than in the comparative example.

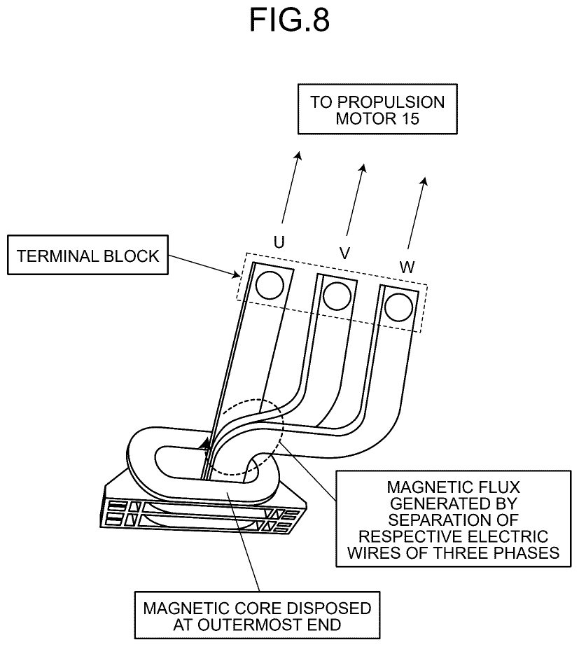

Next, the reason why the analysis results illustrated in FIG. 7 were obtained will be described. FIG. 8 is a diagram for describing the reason why the analysis results illustrated in FIG. 7 were obtained.

When the three-phase alternating-current power line 5 is drawn out of the power conversion apparatus 50, there is a case where the three-phase alternating-current power line 5 is connected to a terminal block for the purpose of fixation or insulation, serving as a relay point of wiring with the outside, as illustrated in FIG. 8. In addition, when the power conversion apparatus 50 is intended for a railroad car, the three-phase alternating-current power line 5 is often formed in a flat plate shape, and the respective electric wires of the three phases are often disposed at intervals at the terminal block. In this case, some of the respective electric wires of the three phases are bent and drawn out of the magnetic core 8 when drawn into the terminal block. There is a case where magnetic flux caused by the electric wire that has been bent and drawn out remains without being canceled out, and local magnetic flux is generated around the magnetic core 8. FIG. 8 illustrates a situation in which local magnetic flux is generated by separation of the respective electric wires of the three phases from each other, the electric wires being drawn out of the magnetic core disposed at the outermost end.

In FIGS. 5 and 6, the three-phase alternating-current power line 5 in a flat plate shape is bent and drawn out of the core members 90 and 92, which are analyzed core members, located at the outermost ends. Therefore, local magnetic flux is generated in the core members 90 and 92. Here, in the core member 90 of FIG. 5 penetrated by the common mode current circulation line 6, part of the local magnetic flux is canceled out by magnetic flux caused by current flowing through the common mode current circulation line 6. In contrast, the local magnetic flux is not canceled out and remains in the core member 92 of FIG. 6 not penetrated by the common mode current circulation line 6. Therefore, it is considered that the magnitude of the magnetic field is smaller in the core member 90 in the configuration of the first embodiment than in the core member 92 in the configuration of the comparative example.

Therefore, when the magnetic core 8 of the first embodiment is used, an increase in the magnetic field can be prevented inside the magnetic core 8, so that the probability of occurrence of magnetic saturation can be reduced. In addition, since the probability of occurrence of magnetic saturation can be reduced when the magnetic core 8 of the first embodiment is used, it is possible to prevent a decrease in the magnetic permeability of the magnetic core 8 due to magnetic saturation.

As described above, the railroad-car power conversion apparatus according to the first embodiment includes: a three-phase inverter that converts direct-current power into alternating-current power for a propulsion motor installed on a railroad car; and a magnetic core penetrated by a three-phase alternating-current power line and a common mode current circulation line. The three-phase alternating-current power line is an electric wire that connects the three-phase inverter and the propulsion motor. The common mode current circulation line is an electric wire that connects a ground potential of the power conversion apparatus and a ground potential of the propulsion motor. The magnetic core includes: first and second cores penetrated by both the three-phase alternating-current power line and the common mode current circulation line; and a third core penetrated only by the three-phase alternating-current power line. The first core is disposed on a side closer to the three-phase inverter, the second core is disposed on a side closer to the propulsion motor, and the third core is disposed between the first core and the second core.

As described above, the railroad-car power conversion apparatus according to the first embodiment includes: the first and second cores penetrated by both the three-phase alternating-current power line and the common mode current circulation line; and the third core disposed between the first core and the second core, the third core being penetrated only by the three-phase alternating-current power line out of the three-phase alternating-current power line and the common mode current circulation line. With this configuration, it is possible to prevent the impedance of the circulation loop of the common mode current circulation line from becoming extremely smaller than the impedance of the circulation loop of the ground circuit including the ground wire. As a result, the power conversion apparatus according to the first embodiment can reduce leakage current while preventing an increase in zero-phase current.

Furthermore, as described above, the railroad-car power conversion apparatus according to the first embodiment has a configuration in which the first and second cores penetrated by both the three-phase alternating-current power line and the common mode current circulation line are disposed at both ends of the third core penetrated only by the three-phase alternating-current power line. With this configuration, it is possible to prevent an increase in the magnetic field of each of the core members located at the outermost ends of the first and second cores. As a result, the probability of occurrence of magnetic saturation can be reduced in the magnetic core, and a decrease in the magnetic permeability of the magnetic core due to magnetic saturation can be prevented.

### Second Embodiment

In a second embodiment, a configuration for further reducing the local magnetic flux described in the first embodiment will be described.

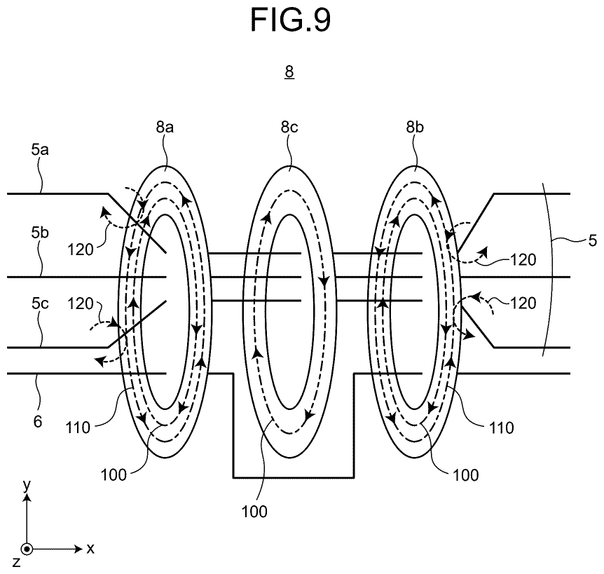

FIG. 9 is a diagram illustrating a situation in which the local magnetic flux described in the first embodiment is generated, on a configuration diagram of the magnetic core 8 of FIG. 4.

FIG. 9 illustrates a situation in which the electric wires 5a and 5c among the three electric wires 5a, 5b, and 5c included in the three-phase alternating-current power line 5 are drawn out of the first core 8a toward the first surface such that the electric wires 5a and 5c are not in parallel with the electric wire 5b. In addition, FIG. 9 illustrates a situation in which the electric wires 5a and 5c among the three electric wires 5a, 5b, and 5c included in the three-phase alternating-current power line 5 are drawn out of the second core 8b toward the second surface such that the electric wires 5a and 5c are not in parallel with the electric wire 5b. Note that in FIG. 9, the same constituent elements as the constituent elements in FIG. 4 are denoted by the same reference numerals.

Furthermore, FIG. 9 illustrates the magnetic fluxes 100 generated by current flowing through the three-phase alternating-current power line 5 and the magnetic fluxes 110 generated by current flowing through the common mode current circulation line 6, and also illustrates local magnetic fluxes 120 indicated by broken lines. The magnetic fluxes 120 may be generated by portions of the electric wires 5a and 5c, the portions being not in parallel with the electric wire 5b. As described above, since the magnetic fluxes 100 and the magnetic fluxes 110 are opposite to each other, the magnetic fluxes 100 and the magnetic fluxes 110 cancel each other out. In contrast, since there is no magnetic flux that cancels out the local magnetic fluxes 120, components of the local magnetic fluxes 120 remain around the first core 8a and the second core 8b or enter the first core 8a and the second core 8b.

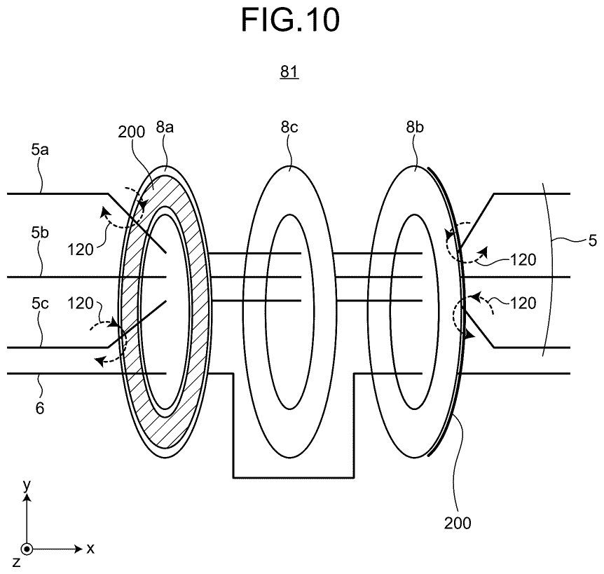

A configuration of a magnetic core 81 illustrated in FIG. 10 is proposed in the second embodiment. FIG. 10 is a diagram for describing a configuration of the magnetic core 81 included in the power conversion apparatus 50 according to the second embodiment. In FIG. 10, the same constituent elements as the constituent elements in FIG. 9 are denoted by the same reference numerals.

In the magnetic core 81 of the second embodiment, a non-magnetic metal plate 200 is installed on the first surface of the first core 8a, and the non-magnetic metal plate 200 is also installed on the second surface of the second core 8b, as illustrated in FIG. 10. An example of the non-magnetic metal plate 200 is an aluminum plate.

In FIG. 10, since the non-magnetic metal plates 200 are disposed on the yz-plane at the first core 8a and the second core 8b, the non-magnetic metal plates 200 interlink with the local magnetic fluxes 120. When the local magnetic fluxes 120 interlink with the non-magnetic metal plates 200, eddy currents flow through the non-magnetic metal plates 200. The eddy currents generate magnetic fluxes in a direction in which the local magnetic fluxes 120 are canceled out, and thus function to prevent the local magnetic fluxes 120 from entering the first core 8a and the second core 8b. As a result, it is possible to prevent the magnetic core 81 from being magnetically saturated by the local magnetic fluxes 120.

When the power conversion apparatus 50 is intended for a railroad car, limitation on the size of the power conversion apparatus 50 is larger on the side closer to the propulsion motor 15 than on the side closer to the three-phase inverter 4, and there is not sufficient empty space on the side closer to the propulsion motor 15 in many cases. Therefore, the non-magnetic metal plate 200 is installed on the second surface of the second core 8b in a preferred embodiment. In addition, when the three-phase alternating-current power line 5 in a flat plate shape is used, it is difficult to draw out all the three electric wires 5a, 5b, and 5c included in the three-phase alternating-current power line 5 in parallel with each other and fix the three electric wires 5a, 5b, and 5c to a terminal block. Therefore, it goes without saying that the non-magnetic metal plate 200 is also installed on the first surface of the first core 8a on the side closer to the three-phase inverter 4 in a more preferred embodiment.

Note that although FIG. 10 shows an example in which the two electric wires 5a and 5c among the three electric wires 5a, 5b, and 5c are not in parallel with the other electric wire 5b, the present embodiment is not limited to this example. Even when one of the three electric wires 5a, 5b, and 5c is not in parallel with the other two electric wires, that is, for example, the electric wire 5a is not in parallel with the electric wires 5b and 5c, it is possible to obtain the effect of reducing the local magnetic fluxes 120 by installing the non-magnetic metal plates 200. That is, when at least one of the three electric wires 5a, 5b, and 5c included in the three-phase alternating-current power line 5 is drawn out of the first core 8a toward the first surface or drawn out of the second core 8b toward the second surface, the effect of reducing the local magnetic fluxes 120 can be obtained by the non-magnetic metal plate 200 as long as the at least one of the three electric wires 5a, 5b, and 5c is not in parallel with remaining one or two electric wires.

### Third Embodiment

In a third embodiment, a description will be given of a preferable thickness of the non-magnetic metal plate 200 in the magnetic core 81 configured as illustrated in FIG. 10. Specifically, the non-magnetic metal plate 200 is proposed which has a thickness equal to or greater than a skin depth in the magnetic core 8 in the power conversion apparatus 50 according to the third embodiment.

The skin depth of a metal plate is a distance at which an electromagnetic field having entered a certain metal material attenuates to 1/e (˜ 1/2.718˜−8.7 dB). Here, when u denotes the magnetic permeability of the non-magnetic metal plate 200, o denotes electric conductivity, and f denotes frequency, a skin depth δ is given by δ=1/√(πfμσ).

When the thickness of the non-magnetic metal plate 200 in the magnetic core 81 is equal to or greater than the skin depth of the material of the non-magnetic metal plate 200, the amount of magnetic flux entering the first core 8 a and the second core 8 b can be kept at 1/e or less as compared with the case where the non-magnetic metal plate 200 is not provided. As a result, the magnetic core 81 can be configured such that magnetic saturation is less likely to occur.

### Fourth Embodiment

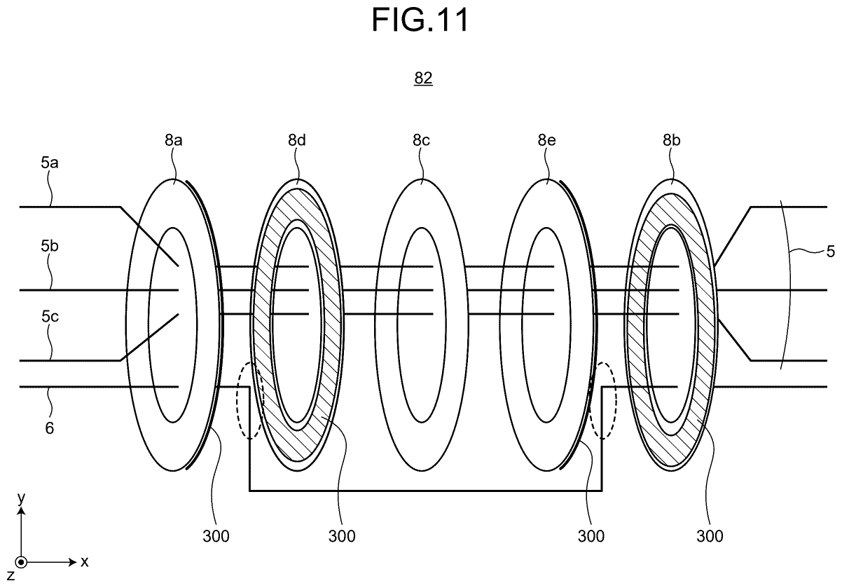

FIG. 11 is a diagram for describing a configuration of a magnetic core 82 included in the power conversion apparatus 50 according to a fourth embodiment. The magnetic core 82 illustrated in FIG. 11 includes a fourth core 8d added between the first core 8a and the third core 8c in the configuration of the magnetic core 81 illustrated in FIG. 10. The fourth core 8d is penetrated only by the three-phase alternating-current power line 5. In addition, the magnetic core 82 illustrated in FIG. 11 includes a fifth core 8e added between the second core 8b and the third core 8c. The fifth core 8e is penetrated only by the three-phase alternating-current power line 5. In addition, in the magnetic core 82 illustrated in FIG. 11, a non-magnetic metal plate 300 is installed on each of the second surface of the first core 8a, the first surface of the fourth core 8d, the second surface of the fifth core 8e, and the first surface of the second core 8b. An example of the non-magnetic metal plate 300 is an aluminum plate. Note that in the configuration of FIG. 11, no non-magnetic metal plate 200 illustrated in FIG. 10 is installed on the first surface of the first core 8a and the second surface of the second core 8b, but the non-magnetic metal plate 200 may be installed thereon as in FIG. 10. The effect to be achieved in the case of including the non-magnetic metal plate 200 is the same as that in the second embodiment.

Next, an effect to be achieved in the case of using the non-magnetic metal plate 300 will be described. First, since the common mode current circulation line 6 penetrates none of the fourth core 8d, the third core 8c, and the fifth core 8e, the common mode current circulation line 6 is bent between the first core 8a and the fourth core 8d and between the fifth core 8e and the second core 8b, as indicated by broken lines, and laid in the magnetic core 82. With this wiring form, local magnetic fluxes as described in the second embodiment are generated at the bent portions. In the fourth embodiment, the non-magnetic metal plate 300 is installed so as to prevent such local magnetic flux from entering the first core 8a and the fourth core 8d and entering the fifth core 8e and the second core 8b. By installing the non-magnetic metal plate 300, it is possible to prevent the magnetic core 82 from being magnetically saturated by the local magnetic fluxes that may be generated by the bent portions of the common mode current circulation line 6.

Note that when the thickness of the non-magnetic metal plate 300 is equal to or greater than the skin depth of the material of the non-magnetic metal plate 200, the same effect as that of the third embodiment can be obtained. Furthermore, in FIG. 11, the non-magnetic metal plate 300 is installed on each of the second surface of the first core 8a, the first surface of the fourth core 8d, the second surface of the fifth core 8e, and the first surface of the second core 8b, but the present embodiment is not limited to this configuration. When an interval between the first core 8a and the fourth core 8d is wider than the thickness of the non-magnetic metal plate 300, the non-magnetic metal plate 300 may be installed only on a surface closer to the bent portion of the common mode current circulation line 6. For example, when the bent portion of the common mode current circulation line 6 is closer to the first surface of the fourth core 8d than to the second surface of the first core 8a, the non-magnetic metal plate 300 may be installed only on the first surface of the fourth core 8d. Similarly, for example, when the bent portion of the common mode current circulation line 6 is closer to the second surface of the fifth core 8e than to the first surface of the second core 8b, the non-magnetic metal plate 300 may be installed only on the second surface of the fifth core 8e.

### Fifth Embodiment

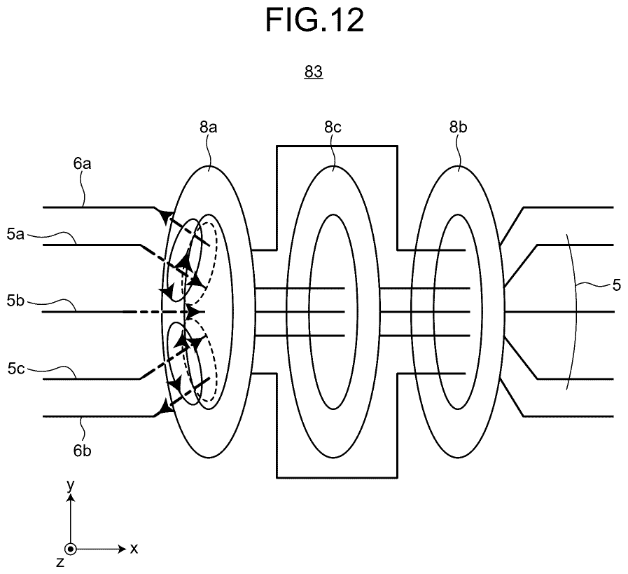

FIG. 12 is a diagram for describing a configuration of a magnetic core 83 included in the power conversion apparatus 50 according to a fifth embodiment. In the magnetic core 83 illustrated in FIG. 12, the common mode current circulation line 6 illustrated in FIG. 10 has been divided into two common mode current circulation lines 6a and 6b. Thus, the common mode current circulation lines 6a and 6b penetrate the first core 8a and the second core 8b. The common mode current circulation line 6a, which is one of the two divided lines, is disposed in such a way as to be in parallel with the electric wire 5a. In addition, the common mode current circulation line 6b, which is the other of the two divided lines, is disposed in such a way as to be in parallel with the electric wire 5c. Note that the term “parallel” used herein refers not only to being parallel in a strict sense, but also to being substantially parallel.

Next, an effect to be achieved by the magnetic core 83 of the fifth embodiment will be described. In FIG. 12, in-phase zero-phase currents indicated by two-dot chain arrow lines flow through the electric wires 5a, 5b, and 5c. Meanwhile, in-phase currents indicated by alternate long and short dash arrow lines flow through the common mode current circulation lines 6a and 6b. The currents flowing through the common mode current circulation lines 6a and 6b and the zero-phase currents flowing through the electric wires 5a, 5b, and 5c are in opposite phase. Therefore, a magnetic flux generated by the current flowing through the electric wire 5a, which is indicated by a solid line, and a magnetic flux generated by the current flowing through the common mode current circulation line 6a, which is indicated by a broken line, are opposite to each other and cancel each other out. Similarly, a magnetic flux generated by the current flowing through the electric wire 5c, which is indicated by a solid line, and a magnetic flux generated by the current flowing through the common mode current circulation line 6b, which is indicated by a broken line, are opposite to each other and cancel each other out. As a result, even when the electric wire 5a is bent and drawn out of the first core 8a and the second core 8b, generation of local magnetic flux is prevented by the common mode current circulation line 6a disposed in such a way as to be in parallel with the electric wire 5a. Thus, it is possible to prevent magnetic flux from entering the magnetic core 83. In addition, even when the electric wire 5c is bent and drawn out of the first core 8a and the second core 8b, generation of local magnetic flux is prevented by the common mode current circulation line 6b disposed in such a way as to be in parallel with the electric wire 5c. Thus, it is possible to prevent magnetic flux from entering the magnetic core 83.

Note that no non-magnetic metal plate 200 is provided in the configuration of FIG. 12, but the non-magnetic metal plate 200 may be installed on the first surface of the first core 8a and the second surface of the second core 8b as illustrated in FIG. 10. Furthermore, in the fifth embodiment, the following configuration has been applied to the configuration of FIG. 10: the common mode current circulation line 6a, which is one of the two divided lines, is disposed in such a way as to be in parallel with the electric wire 5a serving as a first electric wire, which is one of the three electric wires 5a, 5b, and 5c, and the common mode current circulation line 6b, which is the other of the two divided lines, is disposed in such a way as to be in parallel with the electric wire 5c serving as a second electric wire, which is one of the three electric wires 5a, 5b, and 5c. Meanwhile, this configuration may be applied to the configuration according to the fourth embodiment illustrated in FIG. 11. When this configuration is applied to the configuration of FIG. 11, it is also possible to obtain the effect described in the fourth embodiment.

The configurations set forth in the above embodiments show examples, and it is possible to combine the configurations with another known technique or combine the embodiments with each other, and is also possible to partially omit or change the configurations without departing from the scope of the present disclosure.

### Reference Signs List

2, 2A input circuit unit; 3 filter capacitor; 4 three-phase inverter; 4a switching element; 5 three-phase alternating-current power line; 5a, 5b, 5c electric wire; 6, 6a, 6b common mode current circulation line; 7 ground wire; 8, 81, 82, 83 magnetic core; 8a first core; 8b second core; 8c third core; 8d fourth core; 8e fifth core; 10 overhead line; 11 current collector; 12 rail; 13 wheel; 15 propulsion motor; 21 main transformer; 22 converter; 50 power conversion apparatus; 90, 92 core member; 100, 110 magnetic flux; 120 local magnetic flux; 200, 300 non-magnetic metal plate.

1. A railroad-car power conversion apparatus for driving a propulsion motor installed on a railroad car, the railroad-car power conversion apparatus comprising:
a three-phase inverter to convert direct-current power into alternating-current power for the propulsion motor; and
a magnetic core penetrated by a three-phase alternating-current power line and a common mode current circulation line, the three-phase alternating-current power line being an electric wire that connects the three-phase inverter and the propulsion motor, the common mode current circulation line being an electric wire that connects a ground potential of the power conversion apparatus and a ground potential of the propulsion motor, wherein
the magnetic core includes:
a first core disposed on a side closer to the three-phase inverter, the first core being penetrated by both the three-phase alternating-current power line and the common mode current circulation line;
a second core disposed on a side closer to the propulsion motor, the second core being penetrated by both the three-phase alternating-current power line and the common mode current circulation line; and
a third core disposed between the first core and the second core, the third core being penetrated only by the three-phase alternating-current power line, and
assuming that, in each of the first core, the second core, and the third core, a first surface is defined as a surface facing toward the three-phase inverter, and a second surface is defined as a surface facing toward the propulsion motor, when at least one of three electric wires included in the three-phase alternating-current power line is drawn out of the second core toward the second surface, the at least one of the three electric wires is not in parallel with remaining one or two electric wires.

2. The railroad-car power conversion apparatus according to claim 1, wherein
the first core, the second core, and the third core are each formed in a rectangular annular shape or a circular annular shape, and
a non-magnetic metal plate is installed on the second surface of the second core.

3. The railroad-car power conversion apparatus according to claim 1, wherein
a non-magnetic metal plate is installed on the first surface of the first core.

4. The railroad-car power conversion apparatus according to claim 3, wherein
when at least one of the three electric wires included in the three-phase alternating-current power line is drawn out of the first core toward the first surface, the at least one of the three electric wires is not in parallel with remaining one or two electric wires.

5. The railroad-car power conversion apparatus according to claim 2, comprising:
a fourth core disposed between the first core and the third core, the fourth core being penetrated only by the three-phase alternating-current power line; and
a fifth core disposed between the second core and the third core, the fifth core being penetrated only by the three-phase alternating-current power line, wherein
the fourth core and the fifth core are each formed in a rectangular annular shape or a circular annular shape, and
assuming that, in each of the fourth core and the fifth core, a third surface is defined as a surface facing toward the three-phase inverter, and a fourth surface is defined as a surface facing toward the propulsion motor, a non-magnetic metal plate is installed on each of the fourth surface of the first core, the third surface of the fourth core, the fourth surface of the fifth core, and the third surface of the second core.

6. The railroad-car power conversion apparatus according to claim 2, wherein
the non-magnetic metal plate is formed such that the non-magnetic metal plate has a thickness equal to or greater than a skin depth.

7. The railroad-car power conversion apparatus according to claim 1, wherein
the common mode current circulation line is divided into two portions penetrating the first core and the second core.

8. The railroad-car power conversion apparatus according to claim 7, wherein
one of the two portions into which the common mode current circulation line has been divided is disposed in parallel with a first electric wire, the first electric wire being one of the three electric wires included in the three-phase alternating-current power line, and
another of the two portions into which the common mode current circulation line has been divided is disposed in parallel with a second electric wire, the second electric wire being one of the three electric wires included in the three-phase alternating-current power line, the one of the three electric wires being different from the first electric wire.

9. The railroad-car power conversion apparatus according to claim 3, comprising:
a fourth core disposed between the first core and the third core, the fourth core being penetrated only by the three-phase alternating-current power line; and
a fifth core disposed between the second core and the third core, the fifth core being penetrated only by the three-phase alternating-current power line, wherein
the fourth core and the fifth core are each formed in a rectangular annular shape or a circular annular shape, and
assuming that, in each of the fourth core and the fifth core, a third surface is defined as a surface facing toward the three-phase inverter, and a fourth surface is defined as a surface facing toward the propulsion motor, a non-magnetic metal plate is installed on each of the fourth surface of the first core, the third surface of the fourth core, the fourth surface of the fifth core, and the third surface of the second core.

10. The railroad-car power conversion apparatus according to claim 3, wherein
the non-magnetic metal plate is formed such that the non-magnetic metal plate has a thickness equal to or greater than a skin depth.
